(19) United States
(12) Patent Application Publication
(10) Pub. No.: US 2023/0311817 A1
(43) Pub. Date: Oct. 5, 2023

(54) Module housing, mirror replacement system, vehicle

(71) Applicant: ZF CV Systems Global GmbH, Bern (CH)

(72) Inventors: Jan Cohrs, Wietzendorf (DE); Janik Ricke, Uetze (DE)

(21) Appl. No.: 18/311,015

(22) Filed: May 2, 2023

Related U.S. Application Data
(63) Continuation of application No. PCT/EP2021/082996, filed on Nov. 25, 2021.

(30) Foreign Application Priority Data
Dec. 4, 2020 (DE) 10 2020 132 253.4

(51) Int. Cl. B60S 1/56; B60S 1/52; B60S 1/54

(52) U.S. Cl. CPC B60S 1/56; B60S 1/52; B60S 1/54; B60R 1/22

(57) ABSTRACT

A module housing for a mirror replacement system includes a holder body which has at least one holder opening and at least one viewing opening of a camera mount for fastening a camera, wherein the at least one viewing opening enables a view for the camera from the module housing. The holder body furthermore has a retaining device for a cleaning arrangement, wherein the cleaning arrangement has at least one cleaning nozzle and one fluid line for a cleaning fluid with at least one line body, wherein the retaining device has: a line holder for the fluid line, a nozzle holder for the cleaning nozzle which is arranged in such a way that cleaning fluid can be applied from the cleaning nozzle to the at least one viewing opening.

### CROSS-REFERENCE TO RELATED APPLICATIONS

This application is a continuation application of international patent application PCT/EP2021/082996, filed Nov. 25, 2021, designating the United States and claiming priority from German application 10 2020 132 253.4, filed Dec. 4, 2020, and the entire content of both applications is incorporated herein by reference.

### TECHNICAL FIELD

The disclosure relates to a module housing and further relates to a mirror replacement system and to a vehicle.

### BACKGROUND

Module housings, in particular for camera modules for mirror replacement systems, are generally known. One or more side mirrors or similar external rearview mirrors of a vehicle can be replaced by means of a mirror replacement system by a camera recording the area normally covered by the side mirror and playing it back so that it can be seen by the driver of the vehicle with no delay or in real time on a suitable playback unit, in particular a screen. Camera modules of this type preferably have a compact structure, in particular an aerodynamically favorable one, in particular compared with conventional side mirrors. Camera modules of this type also afford advantages over conventional side mirrors in terms of the configuration of a vehicle, in particular because they detract less from the shape of the actual vehicle because of their compact structure. Mirror replacement systems thus offer configuration-related advantages for a vehicle.

Further ergonomic advantages over conventional side mirrors can be obtained by the choice of suitable cameras or camera lenses. The visibility of the outside area can advantageously be improved by cameras with a corresponding wide aperture, as a result of which the driver can better see the outside area in low light, for example at night or in tunnels. The visible area can advantageously likewise be enlarged in particular by the choice of a corresponding focal length of the camera lens, and the road safety of the vehicle and other road users can advantageously be increased. A camera with a wide-angle lens is, for example, suitable for this.

Dirt on the camera and in particular a lens surface of the camera of a camera module, which occurs in particular when the vehicle is being used, is problematic. This is in particular the case because camera modules of this type are generally attached to the outside of the vehicle in order to capture optically a corresponding outside area of the vehicle and are exposed there to corresponding operating and weather conditions.

Cleaning solutions for conventional side mirrors in vehicles already exist. Thus, EP 1084 921 B1 generally shows a method for cleaning an outside rearview mirror on motor vehicles, in particular commercial vehicles such as lorries and buses, in which, after a cleaning procedure has been initiated by the driver, cleaning liquid is first sprayed onto the mirror surface via at least one nozzle on the outside side mirror and then or later the mirror surface is cleaned by means of compressed air by means of which the cleaning liquid and particles of dirt are blown away, wherein the cleaning liquid for cleaning the mirror is diverted in a controlled fashion from a line which is part of a windscreen and/or headlamp cleaning device present inside the vehicle, and the compressed air for cleaning the mirror is supplied in a controlled fashion from a compressed air tank which is part of the compressed air system inside the vehicle.

The system shown in EP 1084 921 B1 thus already in principle advantageously enables the use of cleaning fluids for cleaning a side mirror. A system for cleaning a side mirror by means of compressed air is described in US 7,311,405 B2.

Also problematic is the cleaning of cameras or camera modules in mirror replacement systems. In particular, this relates to a compact and simple structure as well as to integration of a cleaning arrangement into a camera module. In particular, there is no approach in which a cleaning arrangement is provided for a camera module in a compact advantageously aerodynamically favorable manner.

It would therefore be desirable to provide a module housing, for a camera module of a mirror replacement system, which resolves at least one of the problems mentioned and in particular fulfils the abovementioned configuration and ergonomic advantages of mirror replacement systems.

### SUMMARY

It is an object of the disclosure to provide a module housing in an improved fashion which overcomes at least one of the problems mentioned. In particular, it is intended that integration of a cleaning arrangement into a camera module with a compact and simple structure is achieved.

The object, relating to a module housing, is, for example, achieved by the disclosure in a first aspect with a module housing for a mirror replacement system. The module housing includes a holder body defining at least one holder opening and at least one viewing opening of a camera mount for fastening a camera. The viewing opening enables a view for the camera from the module housing. The holder body further having a retaining device for a cleaning arrangement. The cleaning arrangement has a cleaning nozzle and a fluid line for a cleaning fluid with at least one line body. The retaining device having a line holder for the fluid line and a nozzle holder for the cleaning nozzle. The nozzle holder is arranged such that the cleaning fluid can be applied from the cleaning nozzle to the viewing opening.

The disclosure is based on a module housing for a mirror replacement system, with a holder body which has at least one holder opening and at least one viewing opening of a camera mount for fastening a camera, wherein the at least one viewing opening enables a view for the camera, in particular of a lens surface of the camera, from the module housing.

According to the disclosure, it is provided in the case of the module housing that the holder body furthermore has a retaining device for a cleaning arrangement, wherein the cleaning arrangement has at least one cleaning nozzle and one fluid line for a cleaning fluid with at least one line body, wherein the retaining device has:
a line holder, for the fluid line, in particular via a line connection,
a nozzle holder for the cleaning nozzle which is arranged in such a way that
cleaning fluid can be applied from the cleaning nozzle to the at least one viewing opening, in particular the lens surface.

The disclosure is based on the observation that dirt is problematic for mirror replacement systems too as it impairs the camera image and hence affects the view of the driver. The disclosure has recognized that such dirt can be effectively and advantageously removed by means of a cleaning arrangement without a manual cleaning procedure.

Integration of a cleaning arrangement into the module housing, which is advantageous from a configuration point of view, can be effected by a retaining device for the cleaning arrangement with a line holder for the fluid line. Because the holder body has the retaining device, the cleaning arrangement can run inside the holder body and advantageously inside the module housing without affecting an external shape of the camera module.

In particular, the line holder is realized by means of a line guide and/or a line retainer. The fluid line is preferably held in a line guide and line retainers are held therein which retain the fluid line. It may, however, in principle also be advantageous to place the fluid line in the line guide such that the line retainers can be superfluous. One or more suitably realized retaining means can also realize the line guide. For example, the line holder can be realized with a precise fit for the fluid line in any case at certain retaining points such that these retaining points serve as retaining means, in this respect thus instead of the line retainers which are otherwise to be provided separately. Conversely, a line holder can also be realized only with a number of line retainers and they could possibly be attached to an outer side of the holder body such that a line guide inside the holder body could in any case be largely superfluous. A line holder can in this respect be realized in different embodiments, only some of which are mentioned here. An embodiment with reference to the particularly preferred line holder is shown in the drawings and described which is realized by means of a line guide and/or a line retainer.

A retaining device is to be understood within the scope of the disclosure in particular as a number of features including line holders, in particular line guides and/or line retainers, which are produced by adding material to the holder body or by removing material from the holder body and, by virtue of their arrangement and configuration, enable a cleaning arrangement to be held.

It can advantageously be provided that the cleaning nozzle is attached to the fluid line with a plug-in connection. Simple mounting of the cleaning nozzle to the fluid line can advantageously be enabled by means of a plug-in connection. In particular, it is possible by means of a plug-in connection to insert different cleaning nozzles into the module housing in a simple manner. The module housing can be adapted individually to a product or an application during mounting by different cleaning nozzles, in particular to generate different spray patterns and/or to adapt the cleaning power supplied by the cleaning nozzle to cameras of different sizes. In developments, the at least one cleaning nozzle is integrally formed on the holder body and/or the module housing, for example in the form of a one-piece injection-molded part. In such developments, a fluidical connection between the cleaning nozzle on the module housing and the cleaning arrangement, in particular the fluid line, can advantageously be reliably produced by means of a plug-in connection. In other advantageous developments, a cleaning nozzle can be formed by a nozzle body which is separate from the module housing and is inserted into a nozzle holder of the module housing.

It can advantageously be provided that the line retainer is a line clip. A line clip has in particular an elastically deformable clamp or similar leg or hook, by means of which a line body of a fluid line can be held and fastened frictionally and/or positively. In particular, simple mounting can be effected by pressing the line body into the line clip, in particular without there being any need for a further tool. In particular, releasable fastening of a line body of a fluid line can be effected by means of a line clip.

It can advantageously be provided that the line guide is formed as a hollow channel in the holder body. A hollow channel is in particular a channel extending along the fluid line or a line bundle. A hollow channel extends in particular from a line connection to a nozzle holder. A hollow channel can advantageously run inside the holder body but in an edge zone of the holder body and in particular be open to one side such that improved access, in particular for mounting and repair purposes, is advantageously enabled. In particular, a hollow channel can be closed via a cover. A cover can be configured in particular as a lid. A cover can in particular be configured in such a way that, when assembled, it forms a seal flush with the holder body and/or the module housing.

In an embodiment, it is provided that the line connection is formed as a clamping bushing for the fluid line into the holder body. A line body of a fluid line can advantageously be passed through a clamping bushing. In particular, a clamping bushing has elastic material which fits snugly in sealing fashion around the line body which passes through it. Such an elastic material can be formed, for example, by a foam or an elastic plastic material. Existing line bodies for fluid lines which are already present in the vehicle and/or a fluid supply module can advantageously be introduced into a module housing and connected there by means of a clamping bushing.

In an embodiment, it is provided that the line connection is configured as a screw connection and in particular has a bulkhead screw connection, a hose connector or a plug-in screw connection or a combination of these types of line connections.

It can advantageously be provided that the fluid line has a compressed-air fluid line for compressed air, in particular in the form of a compressed-air line body. A cleaning nozzle can advantageously be supplied with compressed air by means of a compressed-air fluid line in order to direct a stream of compressed air and/or a compressed-air cleaning pulse onto a lens surface in order to advantageously remove from the lens surface dirt, moisture and similar artefacts interfering with the camera image.

It can advantageously be provided that the fluid line has a liquid fluid line for a liquid, in particular in the form of a liquid line body. A cleaning nozzle can advantageously be supplied with cleaning liquid by means of a liquid fluid line in order to direct a stream of liquid and/or a liquid cleaning pulse at a lens surface in order advantageously to remove and/or moisten dirt. A cleaning liquid can be formed by water. A cleaning liquid can optionally have further cleaning additives.

In an embodiment, it is provided that a fluid line has a compressed-air fluid line and a liquid fluid line. In particular, such a fluid line has a compressed-air line body and a liquid line body which are advantageously routed parallel to each other in the mirror replacement system, in particular in the module housing, and are particularly advantageously held together or fastened in the form of a line bundle.

It can advantageously be provided that the retaining device has at least one actuator holder for a fluid actuator, in particular a valve, a quick air-release valve, a pressure cylinder or a pump, wherein the actuator holder has a retaining connection and in particular the actuator holder is connected to the line guide. The actuator holder is advantageously integrated into the mirror replacement system, in particular into the module housing.

A fluid actuator describes any device for actuating, in particular switching or conveying, cleaning fluid, in particular compressed air or cleaning liquid. The fluid actuator can be configured in particular as a valve. The valve can advantageously be configured as a 2/2-way valve, in particular as a 2/2-way magnetic valve, in particular as a pneumatic 2/2-way valve for a compressed-air fluid line or as a hydraulic 2/2-way valve for a liquid fluid line. In the case of a hydraulic 2/2-way valve, the vehicle in particular has a further fluid actuator in the form of a pump for conveying the cleaning liquid. The pump can in particular be formed by a pump which serves a different primary purpose, for example a windscreen water pump. A fluid actuator can advantageously be configured as a pressure cylinder which has both an air chamber and a liquid chamber. A pressure cylinder advantageously makes it possible to produce both a liquid cleaning pulse and a compressed-air cleaning pulse with relatively simple structural means, in particular with just a pressure source. This is achieved in particular with a movable divider which is arranged inside the pressure cylinder and partitions the cylinder volume into an air chamber and a liquid chamber and thus divides the two chambers from each other in sealing fashion. By virtue of this divider, pressure can be transmitted between the compressed air and the cleaning liquid, as a result of which the need for a compressed-air source, in particular a liquid pump for the cleaning liquid, can be dispensed with because pressure can be applied to the cleaning liquid by means of the compressed-air source. A liquid cleaning pulse can advantageously be supplied by a pressure cylinder with no hydraulic valves or similar hydraulic switching means. A pressure cylinder accommodated in the module housing enables a liquid cleaning pulse to be supplied close to the cleaning nozzle with advantageously low pressure losses through long fluid lines.

In advantageous developments, it is provided that the retaining device has a number of actuator holders. In particular, cleaning arrangements with a plurality of fluid actuators, preferably connected in series, can be realized by means of a plurality of actuator holders arranged in particular along a line guide.

It can advantageously be provided that the valve is configured as a non-return valve. This is in particular expedient in developments with a combination nozzle and a plurality of, in particular two, fluid lines in order to prevent a cleaning fluid from flowing from one fluid line into the other. An actuator holder for a non-return valve is advantageously arranged close to the cleaning nozzle in order to reduce a dead volume which has to be flushed through with the respective other medium in each cleaning cycle. In particular, a combination line is advantageously kept as short as possible. The use of cleaning fluid, in particular cleaning liquid, is thus advantageously reduced.

In the case of an actuator holder for a quick air-release valve, the module housing advantageously enables the quick air-release valve to be arranged close to the camera with the lens surface to be cleaned. Because of a short line length between the quick air-release valve and the cleaning nozzle, advantageously only small pressure losses occur, which results in a relatively strong compressed-air cleaning pulse with relatively high cleaning power. It can advantageously be provided that the quick air-release valve is arranged in combination with a 3/2-way valve and in particular the retaining device correspondingly has two actuator holders in one line guide.

In an embodiment, it is provided that the retaining device has an actuator holder, configured as a pump holder, for a fluid actuator configured as a pump, wherein in particular the pump holder is connected to the line guide. A pump holder is in particular arranged in or on the line guide for a liquid fluid line. Cleaning liquid can advantageously be conveyed by means of a pump from an in particular unpressurized liquid source and supplied to a cleaning nozzle in particular in the form of a stream of liquid in order to apply it to the lens surface. A pump can be formed in particular as a windscreen water pump or similar advantageously compactly configured pump.

It can advantageously be provided that the retaining connection has a fastening clip for preferably releasably fastening the valve. In particular, the fastening clip is configured to fasten the valve in a predefined actuator position, in particular by means of a frictional and/or positive connection. A pump holder can similarly have a retaining connection, in particular a fastening clip, for fastening the pump. A fastening clip has, in a similar fashion to the line clip, an elastically deformable clamp, leg or similar elastic element for preferably releasably fastening a valve or a pump. A retaining connection, in particular a fastening clip, can thus be configured both for fastening a valve and for fastening a pump. A fastening clip or a line clip advantageously enable simple mounting, in particular without the need for any special tool.

It can advantageously be provided that the retaining connection is a retaining strap or has a retaining strap. A retaining strap is advantageously configured as a flexible and/or elastic strap and configured to grip the fluid actuator for the purpose of being fastened in the actuator holder. A retaining strap can advantageously be configured in the manner of a cable tie and, in a similar fashion to the closing of a cable tie, so that it can positively lock into a retaining strap holder arranged in the actuator holder. A fluid actuator can be assembled by means of a retaining strap with relatively little effort and in particular without the use of a tool.

It can advantageously be provided that the line retainer is configured as a line retaining strap. A line retaining strap is, in a similar fashion to a retaining strap, advantageously configured as a flexible and/or elastic strap and configured to grip one or more line bodies for the purpose of fastening, in particular in the line guide. A line retaining strap can, like a retaining strap, advantageously be configured in the manner of a cable tie and, in a similar fashion to the closing of a cable tie, so that it can positively lock into a line retaining strap holder arranged in the retaining device and the holder body. A line body can be assembled by means of a line retaining strap with relatively little effort and in particular without the use of a tool.

It can advantageously be provided that the retaining device has a holding feature, in particular a holding plug-in connection, which is configured to be brought into engagement with a positioning feature, in particular with a positioning plug, of a valve housing.

It can advantageously be provided that the line retainer is configured as a single line retainer or double line retainer, in particular a single line clip or double line clip. A structurally simple and space-saving parallel arrangement of two fluid lines in the retaining device and the holder body is advantageously achieved by means of a double line retainer.

More than one viewing opening is advantageously provided in the module housing. With a module housing with more than one viewing opening, cameras with more than one lens and correspondingly more than one lens surface can advantageously be held in the module housing. More than one camera mount, in particular with in each case one viewing opening, is advantageously provided. With a module housing with more than one camera mount, a plurality of cameras can advantageously be held in the module housing. Each viewing opening is advantageously associated with at least one nozzle holder for holding a cleaning nozzle.

In a second aspect, the disclosure presents a mirror replacement system for attachment to a vehicle, having a module housing according to the first aspect of the disclosure, and

a cleaning arrangement including at least one cleaning nozzle, in particular a compressed-air cleaning nozzle, a liquid cleaning nozzle and/or a combination nozzle, and at least one fluid line, wherein the cleaning arrangement is held in the retaining device. The advantages of the module housing according to the first aspect of the disclosure are advantageously used in the mirror replacement system according to the second aspect.

The mirror replacement system can advantageously have an electronic control unit for processing the image data captured by means of the camera. The mirror replacement system can advantageously have at least one playback unit, in particular a screen, for displaying the image data captured by means of the camera. In an advantageous development of the mirror replacement system, the cleaning nozzle can be configured as a combination nozzle and have in particular a valve body to which two or more fluid lines, in particular two or more line bodies, can be connected fluidically via in each case one connection. A combination nozzle can advantageously be configured as an annular nozzle. A combination nozzle can be configured in developments to guide a plurality of cleaning fluids completely separately. A combination nozzle can be configured in other developments to mix a plurality of cleaning fluids, for example in accordance with a Venturi or similar principle. In an advantageous development of the mirror replacement system, the cleaning arrangement can have two or more cleaning nozzles, in particular a compressed-air cleaning nozzle and a liquid cleaning nozzle.

In an advantageous development of the mirror replacement system, at least one camera, advantageously precisely one camera, is provided which is held in the camera mount of the holder body and has in particular at least one lens surface arranged in the viewing opening of the camera mount. In developments with a plurality of cameras, a corresponding number of camera mounts and/or viewing openings are advantageously provided. In advantageous developments, the camera has at least one lens, in particular a plurality or lenses, with in each case one lens surface, wherein in particular the at least one lens surface is arranged in a respective viewing opening of the camera mount or in a common viewing opening of the camera mount.

In advantageous developments of the mirror replacement system, it is provided that the cleaning arrangement has at least one fluid actuator, in particular a valve, advantageously a 2/2-way valve or a 3/2-way valve or a non-return valve or a quick air-release valve, or a pressure cylinder or a pump.

In an advantageous development of the mirror replacement system, it is provided that the cleaning arrangement has a quick air-release valve which is configured to receive compressed air and to supply a compressed-air cleaning pulse to the cleaning nozzle, wherein the quick air-release valve is held in an actuator holder of the retaining device. The cleaning arrangement can advantageously have a further valve, in particular a 3/2-way valve, for the admission and release of air at the quick air-release valve.

In an advantageous development of the mirror replacement system, it is provided that the fluid actuator has an actuator housing with a positioning feature, in particular with a positioning plug which can be brought into engagement with a holding feature, in particular a holding plug connection of the holder body, in order to fix an actuator position of the actuator housing relative to the module housing. The actuator housing can be formed, for example, by a valve housing or a quick air-release valve housing or a pump housing.

In an advantageous development of the mirror replacement system, a fluid supply module is provided, configured to supply a compressed-air cleaning pulse and/or a stream of compressed air and/or a liquid cleaning pulse and/or a stream of liquid.

In a third aspect, the disclosure presents a vehicle, in particular a commercial vehicle or car, having:

a module housing according to the first aspect of the disclosure or a mirror replacement system according to the second aspect of the disclosure. In particular, the vehicle has a compressed-air supply system for supplying compressed air. In particular, the module housing or the mirror replacement system is arranged and configured in such a way that the camera is arranged with a lens surface for the optical capture of an outside area, in particular an outside area towards the rear, of the mirror replacement system. In the case of the vehicle according to the third aspect of the disclosure, the advantages of the module housing according to the first aspect or of the mirror replacement system according to the second aspect of the disclosure are advantageously used. A commercial vehicle includes in particular trucks, agricultural vehicles and construction machinery. In particular in the case of commercial vehicles which are generally exposed to dirt when in use, for example in agriculture or the construction industry, a module housing and a mirror replacement system according to the concept of the disclosure can be used particularly advantageously.

It should be understood that the module housing according to the first aspect of the disclosure, the mirror replacement system according to the second aspect of the disclosure and the vehicle according to the third aspect of the disclosure have the same and similar subaspects as are stipulated. In this respect, for a development of one aspect of the disclosure, reference is also made to the developments of the other aspects of the disclosure.

### BRIEF DESCRIPTION OF DRAWINGS

The invention will now be described with reference to the drawings wherein:

FIG. 1 shows a module housing according to the concept of the disclosure of a camera module for a mirror replacement system;

FIG. 2 shows a perspective view of the module housing shown in FIG. 1;

FIG. 3A, FIG. 3B each show a perspective view of a schematically illustrated vehicle in the form of a commercial vehicle with a module housing according to the concept of the disclosure;

FIG. 4A, FIG. 4B, FIG. 4C, FIG. 4D, FIG. 4E show schematic illustrations of different advantageous and developments of module housings for different cleaning arrangements;

FIG. 4F shows a pressure cylinder;

FIG. 5A shows a quick air-release valve;

FIG. 5B, FIG. 5C show two views of an actuator housing with positioning features shown by way of example;

FIG. 6 shows a schematic plan view of a vehicle with a mirror replacement system with module housings according to the concept of the disclosure;

FIG. 7A, FIG. 7B, FIG. 7C show different advantageous line connections;

FIG. 8A, FIG. 8B show different advantageous line switches; and,

FIG. 8C, FIG. 8D show different advantageous retaining connections.

### DETALLED DESCRIPTION

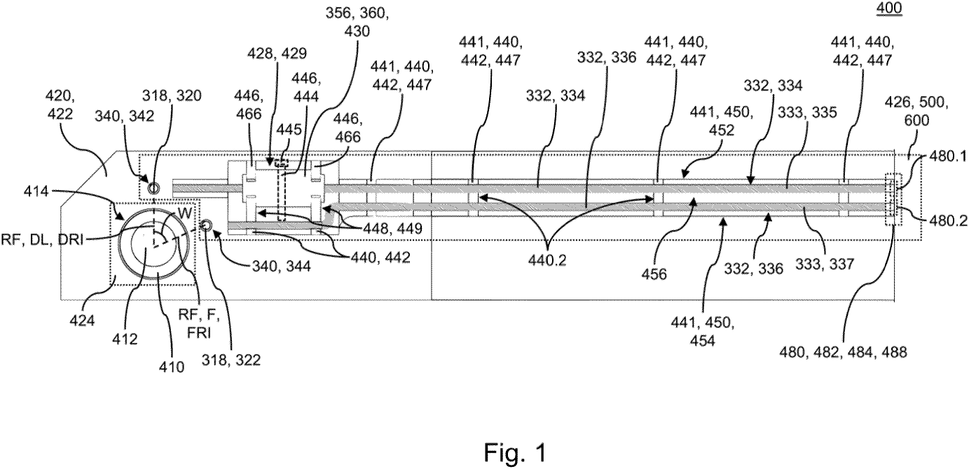

FIG. 1 shows a module housing 420 of a camera module 400 for a mirror replacement system 900. The module housing 420 has a holder body 422. The holder body 422 has a retaining device 426 which is advantageously configured to hold a cleaning arrangement 500. The module housing 420 is advantageously configured as a holder body 422. The module housing 420 and/or the holder body 422 and/or the retaining device 426 is advantageously formed from a suitable plastic which has a sufficient mechanical and chemical stability to be resistant to external influences during use on the vehicle. A suitable plastic can be, for example, acrylonitrile butadiene styrene (ABS) or polycarbonate (PC) or another plastic or a combination thereof.

The module housing 420 has at least one viewing opening 414 and, arranged relative thereto, at least one camera mount 424. The camera mount 424 and/or the viewing opening 413 is advantageously configured as a recess in the holder body 422. The camera mount 424 is advantageously configured to releasably fasten a camera 410 in a defined position, for example via screws or via elastic clamps, clips, snap-fits or similar elastic elements. The camera 410 is fastened in the camera mount 424 in such a way that a lens surface 412 of the camera 410 has a free view through the viewing opening 414 out of the module housing 420. The camera 410 is advantageously fastened in the camera mount 424 in such a way that the lens surface 412 is arranged in the viewing opening 414.

The module housing 420 has at least one nozzle holder 340 which is configured to hold a cleaning nozzle 318. The embodiment shown in the present case has a first nozzle holder 340 in the form of a compressed-air nozzle holder 342 which is configured to hold a compressed-air cleaning nozzle 320, and a second nozzle holder 340 in the form of a liquid nozzle holder 344 which is configured to hold a liquid cleaning nozzle 322. In other advantageous embodiments, the nozzle holder 340 can be configured to hold a combination nozzle 324. The at least one nozzle holder 340 is configured in particular as a recess in the holder body 422. The at least one nozzle holder 340 is configured and arranged in such a way that a cleaning nozzle 318 held therein directs a cleaning fluid RF onto the lens surface 412. In the case of embodiments with a plurality of, in particular two, nozzle holders 340, the latter are advantageously arranged offset by an angle W about a center point of the lens surface 412, wherein the angle W is preferably between 0 and 90°. The nozzle holder 340 and/or the cleaning nozzle 318 is connected fluidically via a fluid line 332. The fluid line 332 has a line body 333, in particular a compressed-air line body 335 and/or a liquid line body 337. The cleaning arrangement 500 advantageously has a first fluid line 332 in the form of a compressed-air fluid line 334, and a second fluid line 332 in the form of a liquid fluid line 336. The compressed-air fluid line 334 has a line body 333 in the form of a compressed-air line body 335 and the liquid fluid line 336 has a line body 333 in the form of a liquid line body 337. The module housing 420, in particular the retaining device 426, or the cleaning arrangement 500 has a holder opening 423 through which the at least one fluid line 332 and any further lines such as camera lines 902 and/or control lines 904 can advantageously be routed from the vehicle 1000 into the module housing 420. The holder opening 423 is advantageously configured and arranged in such a way that, in the assembled state of the module housing 420, it is not visible and is advantageously covered in sealing fashion by the vehicle 1000, in particular by an A-pillar 1008 of the vehicle 1000. The holder opening 423 can advantageously be configured to fasten the module housing 420 to the vehicle 1000, in particular to an A-pillar 1008 of the vehicle 1000, and for this purpose can have at least one screw connection such as, for example, a threaded bore, or a positively releasably lockable fastening device such as, for example, one or more snap-fits.

The module housing 420, in particular the holder opening 423, can have a line connection 480, in particular in the form of a plug-in connection 482. The cleaning arrangement 500 can be connected fluidically to one or more cleaning fluid sources, in particular a compressed-air source and/or a liquid source. In the present case, the line connection 480 has a first line connection 480.1 for the compressed-air fluid line 334, and a second line connection 480.2 for the liquid fluid line 336. In other advantageous embodiments, the line connection 480 can be configured as a clamping bushing 484.

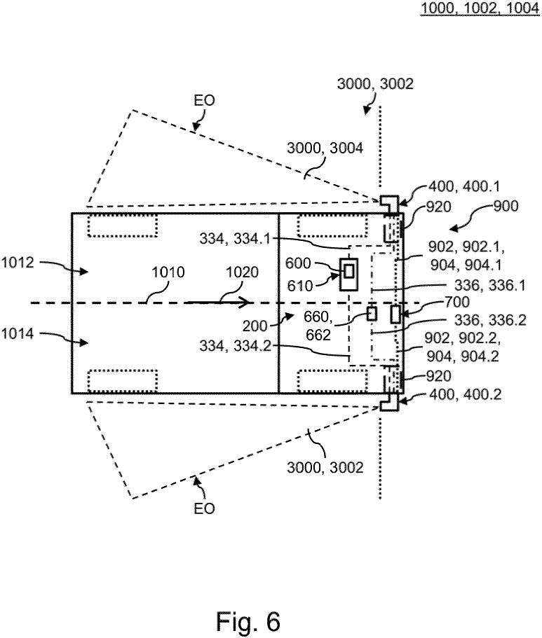

In other advantageous embodiments, the line connection 480 can be configured as a screw connection 488, in particular a bulkhead screw connection 488A, a hose connector 488B or a plug-in screw connection 488C or a combination of the above-mentioned types of line connections 480. A bulkhead screw connection 488A, as shown by way of example in FIG. 7A, can advantageously be arranged in a bore in a housing wall 421 of the module housing 420, advantageously on the vehicle side 490 of the module housing 420. The bulkhead screw connection 488A can advantageously be screwed tightly from outside by means of a nut 494 on a thread 489 and hence be fastened to the housing wall 421. Line bodies 333 of fluid lines 332 coming from the vehicle 1000 can advantageously be screwed onto the thread 489. A hose connector 488B, as shown by way of example in FIG. 7B, can advantageously be screwed into the housing wall 421 by means of an insert thread 495, as shown in FIG. 7B, and/or onto a threaded connection, on the module housing, of the line body 333 of a fluid line 332. A line body 333, coming from the vehicle 1000, of a fluid line 332 can be plugged onto the hose connector 488B in order to produce a fluidical connection and in particular be fixed with a hose clamp.

A plug-in screw connection 488C, as shown by way of example in FIG. 7C, can be screwed into the housing wall 421 by means of an insert thread 495, as shown in FIG. 7C, and/or onto a threaded connection, on a module housing, of the line body 333 of a fluid line 332. A line body 333, coming from the vehicle 1000, of a fluid line 332 can be plugged into the plug-in screw connection 488C in order to produce a fluidical connection.

A holder opening 423, in particular a line connection 480, can advantageously be configured so that it can rotate, in particular about a module axis AM, in order to enable rotatable adjustment of the camera module 400, advantageously when the vehicle 1000 is being operated. For this purpose, the line connection 480, in particular a plug-in connection 482 or a clamping bushing 484, is advantageously likewise configured and/or arranged rotatably.

In the present case, a line holder 441 is realized by means of a line guide 440 and a line retainer 450. The fluid line is thus advantageously held in the line guide 441 and the line retainers 450, which retain the fluid line, are arranged therein.

In the case of simplified embodiments not shown here, it may in principle also be advantageous to place the fluid line in the line guide such that the line retainers can be superfluous in a first embodiment not shown here. In an embodiment not shown here, one or more suitably realized retaining means can also be realized. For example, the line holder can be realized with a precise fit for the fluid line in any case at certain retaining points such that these retaining points serve as a retaining means, in this respect thus instead of the line retainers which are otherwise to be provided separately. Conversely, a line holder can also be realized only with a number of line retainers and they could possibly be attached to an outer side of the holder body such that a line guide inside the holder body could in any case be largely superfluous. A line holder can in this respect be realized in different embodiments, only some of which are mentioned here.

An embodiment with reference to the particularly preferred line holder 441, which is realized by means of a line guide 450 and a line holder 440, is shown and described below in any case with further reference to the drawings.

In the present case, the retaining device 426 of the module housing 420 has a line guide 450 which is configured to hold one or more fluid lines 332. Overall, the module housing 420 also has a line guide 450 for in each case one fluid line 332, for example in the form of a compressed-air line guide 452 for the compressed-air fluid line 334, and a liquid line guide 454 for the liquid fluid line 336. In other embodiments, as shown here, a common line guide 450 can be provided for all the fluid lines 332 which are advantageously routed in parallel to one another. The common line guide 450 can advantageously be configured to hold further lines, in particular electrical control lines 904 and/or camera lines 902, or a line bundle 920 including a plurality of lines. The line guide 450 is configured in the present case as a hollow channel 456, that is, here in the holder body 422. The hollow channel 456 is advantageously, as shown here, open on an outer side of the module housing 420 and can be closed by means of a cover which is not illustrated here.

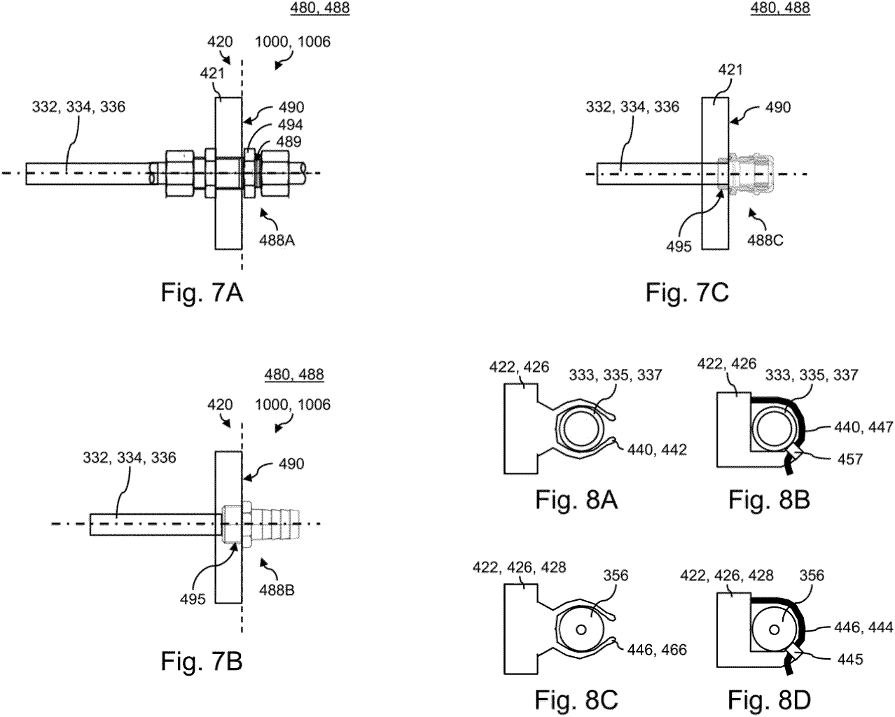

In particular, such a cover can be fastened on the module housing 420 and the holder body 422 by means of screws or snap-fits in order to cover the hollow channel 456 so that it is closed. A number of line retainers 440 are provided in the line guide 450, in particular in the hollow channel 456, for the retaining device 426 in order to fasten, in particular releasably fasten, the fluid line 332. The line retainer 440 is advantageously configured as a line clip 442, as also shown schematically in FIG. 8A. A line clip 442 is advantageously configured as an elastic clamp which is temporarily deformed during mounting when the line body 333, 335, 337 is attached in the line 442 and, when the line body 333, 335, 337 is arranged in the line clip 442, is retained in position by the latter positively and/or frictionally. The line retainer 440 can be configured as a single line retainer 440.1, advantageously as a single line clip 442.1. In embodiments in which a plurality of, preferably two, fluid lines 332 are guided in a common line guide 450, the line retainer 440 is advantageously configured as a multiple line retainer, in particular as a double line retainer 440.2 and/or double line clip 442.2.

The retaining device 426 of the module housing 420 can have one or more actuator holders 428 for holding a fluid actuator 356, in particular a valve 360. The actuator holder 428 is advantageously configured as a recess in the holder body 422. The fluid actuator 356 can advantageously, as shown here, be configured as a quick air-release valve 430. In other advantageous cleaning arrangements 500, a fluid actuator 356 can alternatively or additionally be configured in a different form, in particular as a 2/2-way valve 364 or as a 3/2-way valve 372. The actuator holder 428 advantageously has a retaining connection 446 for in particular releasably fastening the valve 360. The retaining connection 446, as also shown schematically in FIG. 8C, is advantageously configured as a fastening clip 466. The fastening clip 466 advantageously has, in a similar fashion to the line clip 442, one or more elastic clamps or similar elastic legs or snap-fits. A line retainer 440 and a retaining connection 446 can advantageously be configured jointly, advantageously in a single piece, as a combination retainer 448. In particular, a line clip 442 and a fastening clip 466 can be configured together, advantageously in a single piece, as a combination clip 449. In particular, the line retainer 440 or the retaining connection 446 is integrally formed in a single piece on the holder body 422. Alternatively or additionally, the actuator holder 428 can, as also shown schematically in FIG. 8D, have a retaining connection 446 in the form of a retaining strap 444. A retaining strap 444 is advantageously configured as a flexible and/or elastic strap and configured to grip the fluid actuator 356 for the purpose of fastening in the actuator holder 428. A retaining strap 444 can advantageously be configured in the manner of a cable tie and, in a similar fashion to the closing of a cable tie, so that it can positively lock into a retaining strap holder 445 arranged in the actuator holder 428. In a similar fashion (this is shown schematically in FIG. 8B), a line retainer 440 can be configured as a line retaining strap 447 for fixing one or more line bodies 333. The line retaining strap 447 can advantageously be configured in the manner of a cable tie and, in a similar fashion to the closing of a cable tie, so that it can positively lock into a line retaining strap holder 457.

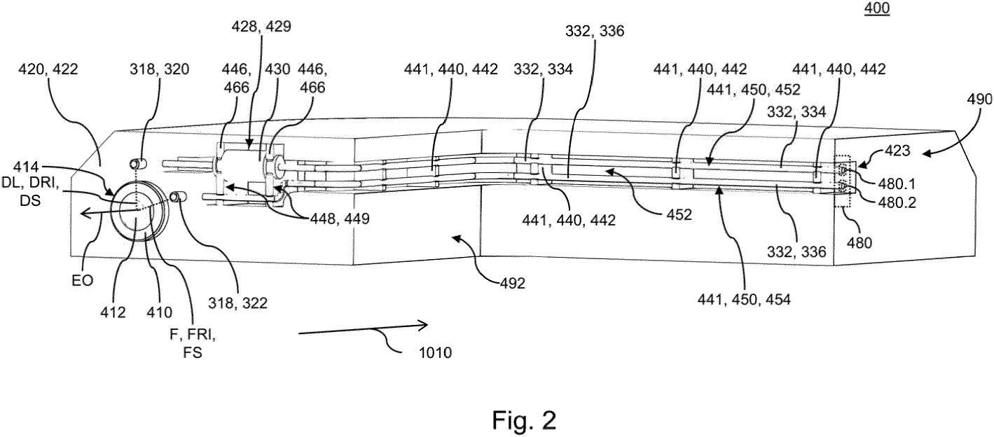

FIG. 2 shows the embodiment shown in FIG. 1 in a perspective illustration. In this illustration, in particular two side surfaces, namely a vehicle side 490 and a step side 492 of the module housing 420, are visible. The vehicle side 490 is configured in particular for attachment to a vehicle 1000, in particular to an A-pillar 1008 of a vehicle 1000 and for this purpose has corresponding attachment means which are not illustrated further here. For the sake of greater clarity, a vehicle body axis 1010 is marked in FIG. 2 which indicates the alignment of a vehicle 1000 to which the camera module 400 can be attached. Orientation of the camera 410 and the lens surface 412, by means of which optical capture EO of an outside area 3000 of the vehicle 1000, in particular an outside area towards the rear 3002, is possible, results from this alignment.

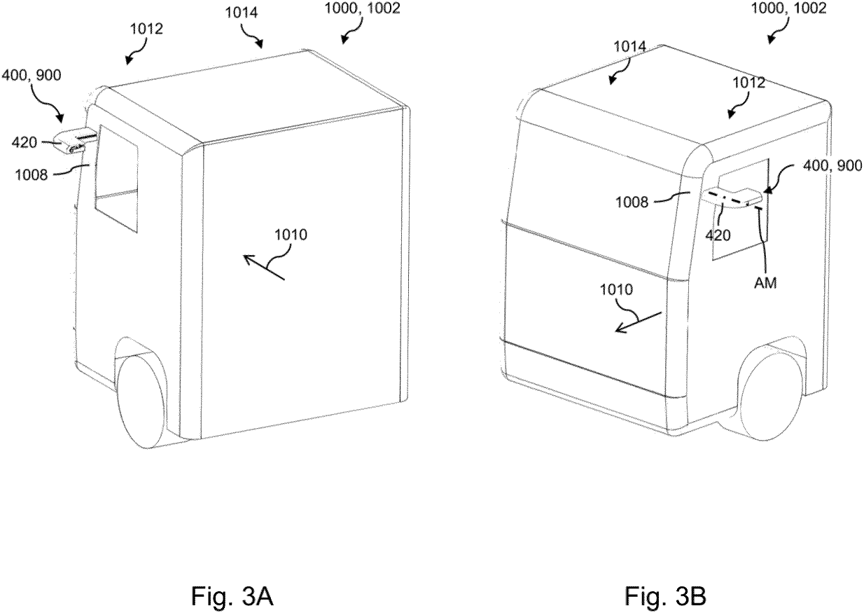

FIG. 3A and FIG. 3B show schematically a vehicle 1000 configured as a commercial vehicle 1002 which has a mirror replacement system 900 with a camera module 400. The camera module 400 is arranged in the present case on a driver’s side 1012, here on the left-hand side of the vehicle 1000 viewed in the direction of the vehicle body axis 1010. Particularly advantageously, the vehicle can alternatively or additionally likewise have a camera module 400 on an opposite passenger side 1014, here the right-hand side of the vehicle 1000. A camera module 400 on the passenger’s side 1014 is particularly advantageous because it can prevent accidents with road users situated on the passenger’s side 1014 of the vehicle, in particular cyclists, in particular when the vehicle 1000 makes a turn. Furthermore, it is possible for a driver of the vehicle 1000 to clean the lens surface 412 of a camera module 400 arranged on the side opposite the driver’s seat only with a great deal of effort because of the distance, for which reason a cleaning arrangement 500 in a module housing 420 according to the disclosure is particularly advantageous. In the case of vehicles 1000 with a correspondingly reversed arrangement of the driver’s seat, in particular in countries where you drive on the left, these advantages similarly apply for a correspondingly reversed arrangement.

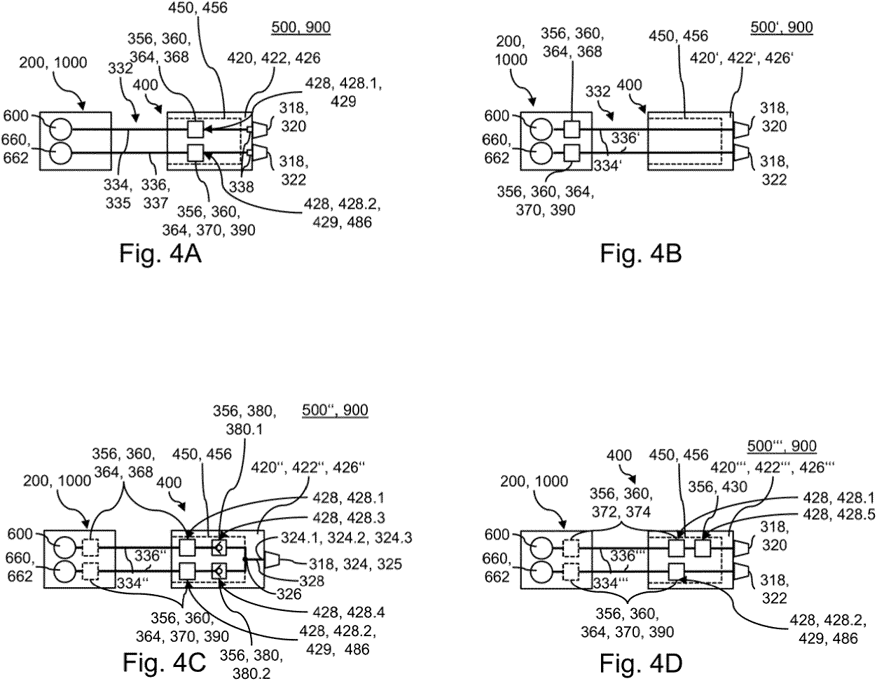

FIG. 4A, FIG. 4B, FIG. 4C and FIG. 4D show by way of example different options for the arrangement of elements of a cleaning arrangement 500 for a mirror replacement system 900 and correspondingly adapted module housing 420 within the scope of the disclosure.

Shown in FIG. 4A is a module housing 420 of a camera module 400 with a holder body 422 with a retaining device 426 which has a line holder 450 in the form of a hollow channel 456. The line holder 450 is configured as a common line holder 450 for a first compressed-air fluid line 334 and a second liquid fluid line 336. The compressed-air fluid line 334 is connected fluidically to a compressed-air source 600, in particular of a compressed-air supply system. The liquid fluid line 336 is connected fluidically to a liquid source 660, for example a windscreen water tank 662. The liquid source 600 can have a pump 390 for conveying cleaning liquid.

The retaining device 426 of the module housing 420 can have, in particular in the holder body 422, one or more actuator holders 428, in particular valve holders 429 or pump holders 486. In the present case, the holder body 422 has a first actuator holder <us-rn>428.1</us-rn> for holding a fluid actuator 356, here in the form of a valve 360, in the first compressed-air fluid line 334. The valve 360 held in this actuator holder 428 can in particular be configured as a 2/2-way valve 364, in particular as a pneumatic 2/2-way valve 368. A compressed-air fluid line 334 can be selectively opened and closed by means of a 2/2-way valve 364 in order in this way to supply compressed air DL to the cleaning nozzle 318, here to the compressed-air cleaning nozzle 320.

In the present case, the holder body 422 has a further second actuator holder 428.2 for holding a fluid actuator 356 configured as a valve 360 in the liquid fluid line 336. The valve 360 held in this second actuator holder 428.2 can be configured in particular as a 2/2-way valve 364, in particular a hydraulic 2/2-way valve 370. Alternatively or additionally, the holder body 422 can have an actuator holder 428 configured as a pump holder 486 which is configured to hold a fluid actuator 356 configured as a pump 390. The pump 390 can be configured in particular as an electric pump 390. Such a pump 390 is, in embodiments in which the liquid source 660 is configured as unpressurized, in particular advantageously, for example, a windscreen water tank 662. A pump 390 is configured to convey cleaning liquid. Cleaning liquid F can be supplied to the cleaning nozzle 318, here to the liquid cleaning nozzle 322, selectively by electrically activating the pump. Each cleaning nozzle 318 can advantageously be connected fluidically to a fluid line 332 by means of a plug-in connection 338.

A further cleaning arrangement 500′ with a further camera module 400′ and a further holder body 422′ with a retaining device 426′ is illustrated in FIG. 4B. In contrast to FIG. 4A, the further holder body 422′ has just the line holder 450 but no actuator holders 428 because the fluid actuators 356, in particular valves 360 or any pumps 390, are arranged not in the further module housing 420′ or the further holder body 422′ and instead in the vehicle 1000, possibly in a fluid supply module 200.

A still further advantageous cleaning arrangement 500″ with a correspondingly configured still further holder body 422″ of a still further module housing 420″ with a still further retaining device 426″ is shown in FIG. 4C. The still further holder body 422″ has further actuator holders 428.3, 428.4, in each case for holding a fluid actuator 356 configured as a non-return valve 380. In the present case, the third actuator holder 428.3 has a first non-return valve 380.1, and a fourth actuator holder 428.4 has a second non-return valve 380.2. The first non-return valve 380.1 is arranged in the compressed-air fluid line 334 and the second non-return valve 380.2 is arranged in the liquid fluid line 336. Correspondingly, the third actuator holder 428.3 and the fourth actuator holder 428.4 are arranged in the holder body 422.

The provision of a non-return valve 380, in particular of a first and second non-return valve 380.1, 380.2 advantageously enables, in an improved fashion, the use of a combination nozzle 324 as a cleaning nozzle 318. A non-return valve 380 in a first fluid line 332 prevents, when a cleaning fluid RF is passed through a further fluid line 332 connected to the combination nozzle 324, this cleaning fluid RF from entering the first fluid line 320. A combination nozzle 324 is preferably formed from a nozzle body 325. A combination nozzle 324 can have a combination connection 324.1 for connecting a combination line 328. In the present case, the combination line 328 is connected fluidically to the compressed-air fluid line 334 and the liquid fluid line 336 via the line junction 326. In alternative cleaning arrangements 500, a combination nozzle 324 can have separate connections, in particular a compressed-air cleaning connection 324.2 which is configured to fluidically connect the compressed-air fluid line 334, and a liquid cleaning connection 324.2 which is configured to fluidically connect the liquid fluid line 336. In such configurations of the combination nozzle 324, the two lines are preferably joined inside the nozzle body 325.

The still further holder body 422″ can optionally have further actuator holders 428 for holding a fluid actuator 356, for example valve actuators 429 such as, as shown here, the first actuator holder 428.1 and the second actuator holder 428.2, or pump holders 486 for holding a pump. Alternatively, however, fluid actuators 356 required to switch or convey the cleaning fluid RF can also be arranged in the vehicle 1000 and/or in a fluid supply module 200, as indicated here in dashed lines.

FIG. 4D shows a still further module housing 420‴ with a still further holder body 422‴ with a still further retaining device 426‴ for a still further cleaning arrangement 500‴, with a further actuator holder 428 in the form of a fifth actuator holder 428.5 for holding a fluid actuator 356 configured as a quick air-release valve 430. The quick air-release valve 430 is preferably arranged in the compressed-air fluid line 334. The quick air-release valve 430 is preferably combined with a valve 360 configured as a 3/2-way valve, in particular as a pneumatic 3/2-way valve 374, in order to admit and release air at the quick air-release valve 430 in accordance with its mode of functioning as described below.

FIG. 4E shows a still further module housing 420‴ with a still further holder body 422‴ with a still further retaining device 426‴ for a still further cleaning arrangement 500‴. The still further cleaning arrangement 500‴ has in an actuator holder 428, in particular in a third actuator holder 428.3, a pressure cylinder 220, and in a further actuator holder 428, in particular in a first actuator holder 428.1, a fluid actuator 356 configured as a 3/2-way valve 372. The pressure cylinder 220 and the 3/2-way valve 372 are connected pneumatically to each other via a connecting fluid line 260. The 3/2-way valve 372 is in particular configured as a pneumatic 3/2-way valve 374. Also, arranged in the line holder for the liquid fluid line 334‴ are a second and third actuator holder 428.2, 428.3 in which in each case a non-return valve 380, namely a third non-return valve 380.3 and a fourth non-return valve 380.4, are arranged.

FIG. 4F shows in detail an individual fluid actuator 356 configured as a pressure cylinder 220, in a side view in cross-section. The pressure cylinder 220 has a divider 226 in the form of a cylinder ram 227 which is arranged inside the cylinder volume VZ of the pressure cylinder 220 so that it can move axially along the cylinder axis AZ and bears pressure-tightly against an inner wall 536 of the pressure cylinder 220. The cylinder ram 227 thus divides the cylinder volume VZ, in a modifiable manner, into an air chamber 222, holding compressed air DL, with an air chamber volume VL, and a liquid chamber 224, holding cleaning liquid F, with a liquid chamber volume VF. The air chamber 22 is divided fluid-tightly from the liquid chamber 224 by virtue of the fact that the cylinder ram 227 bears against the inner wall 536 of the pressure cylinder 220 over the circumference of the cylinder ram 227. On the one hand, compressed air DL can be applied to the air chamber 222 via an air chamber connection 223 in order to generate an applied force acting on the cylinder ram 227 and, on the other hand, for the purpose of supplying a compressed-air cleaning pulse DRI, compressed air DL is output as a compressed-air cleaning pulse DRI by the divider 226 which moves backwards under the restoring force. The air pressure of the compressed-air cleaning pulse DRI is here in particular the result of the restoring force multiplied by a ram surface area AS of the cylinder ram 227. The liquid chamber 224 can draw in cleaning liquid F, and output it in order to supply a liquid cleaning pulse FRI, via a liquid chamber connection 225.

Optionally, the cylinder ram 227 can, in order to better seal the air chamber 222 from the liquid chamber 224, have a seal 229, in particular made from plastic and/or rubber. The cylinder ram 227 is retained in the cylinder volume VZ of the pressure cylinder 220 by a restoring spring 228 such that, in the case of a deflection, caused in particular by air pressure being applied to the air chamber connection 223, a restoring force FR is generated.

The pressure cylinder 220 can have a cylinder volume VZ of between 5 ml and 80 ml, preferably between 10 ml and 40 ml, particularly preferably between 10 and 20 ml.

If the 3/2-way valve 372 is situated in an air-admission position 372A, air pressure supplied by the compressed-air source 600 is forwarded to the air chamber connection 223, which causes expansion of the air chamber 222 and the supply of a liquid cleaning pulse FRI to the liquid chamber connection 225 and hence to the liquid cleaning nozzle 322 (or a combination nozzle 324 which is not illustrated here). The third non-return valve 380.3 prevents the liquid cleaning pulse FRI from flowing back in the direction of the line connection or the liquid source 660.

In an air-release position 372B of the 3/2-way valve 372, the air chamber connection 223 is pneumatically connected to the compressed-air cleaning nozzle 320 (or a combination nozzle 324 which is not illustrated here), as a result of which the air chamber connection 223 is bled and the divider 226 is moved backwards by the restoring force FR. As a result, both the air chamber volume VL of the air chamber 222 is reduced and the liquid chamber volume VF of the liquid chamber 224 is enlarged. A reduced pressure at the liquid chamber connection 225 is created by the backward movement of the divider 226. By virtue of the fourth non-return valve 380.4, the reduced pressure acts only in the direction of the liquid source 660 (and not at the cleaning nozzle 318, here the liquid cleaning nozzle 322), as a result of which new cleaning liquid F is drawn from the liquid source 660 into the liquid chamber 224, in particular advantageously without there being any need for a pump or similar conveying device or a hydraulic switch valve.

The embodiments shown in FIG. 4A, FIG. 4B, FIG. 4C, FIG. 4D, FIG. 4E, and FIG. 4F can be combined as desired, in particular in relation to the arrangement of actuator holders 428, in particular valve holders 429 or pump holders 486, for individual fluid lines 332 in a holder body 422. For example, the compressed-air fluid line 334 shown in FIG. 4A can be combined with the liquid fluid line 336′ shown in FIG. 4B, or conversely the liquid fluid line 336 shown in FIG. 4A with the compressed-air fluid line 334′ shown in FIG. 4B. Also, a combination nozzle 324 and/or line junction 326 shown in FIG. 4C can be combined with all the other embodiments shown. Also, the quick air-release valve 430 shown in FIG. 4D, in particular preferably together with a 3/2-way valve 372, can be combined with all the other embodiments shown. For example, the quick air-release valve 430 shown in FIG. 4D can also be arranged with no further valves 360 in the module housing 420 or the holder body 422, as illustrated in the embodiment shown in FIG. 1 and FIG. 2. In this case, the cleaning fluid RF is switched and/or conveyed via valves arranged in the vehicle 1000.

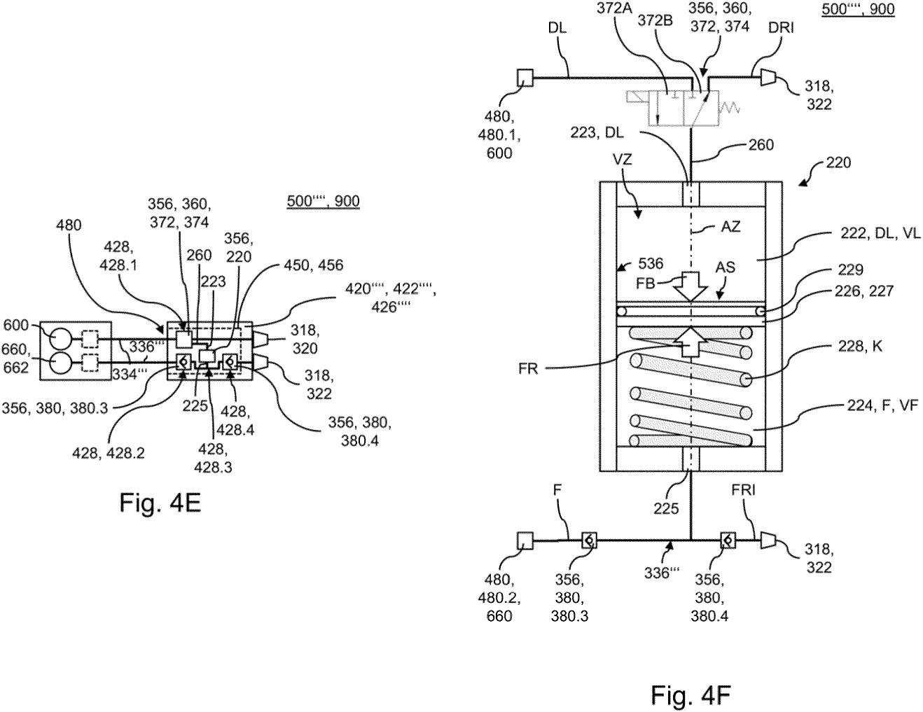

FIG. 5A shows a quick air-release valve 430 schematically in a cross-section. The quick air-release valve 430 is configured to receive compressed air DL via the compressed-air fluid line 334 and to output compressed air DL in the form of a compressed-air cleaning pulse DRI which is supplied to the cleaning nozzle 318, in particular a compressed-air cleaning nozzle 320 or a combination nozzle 324. A valve ram 433 which can move along a valve axis AV is arranged inside a valve housing 432 with a preferably cylindrical structure. Compressed air DL is passed into the valve housing 432 via a first valve connection 430.1 by a valve 360, in particular a 3/2-way valve 372, being switched into an air-admission position 372A. The compressed air DL can, as illustrated here with the arrows, flow past the valve ram 433 into a charging space 432.1. The charging space 432.1 is formed annularly between the valve housing 432 and a tubular annular projection 432.2 arranged inside the valve housing. The valve ram 433 is pressed against the end of the annular projection 432.2 by the entering compressed air DL. In the case of the release of air by means of the valve 360, in particular switching the 3/2-way valve 372 into an air-release position 372B, the pressure of the compressed air DL at the first valve connection 430.1 decreases suddenly, as a result of which the compressed air contained in the charging space 432.1 escapes as a pulse in the form of a compressed-air cleaning pulse through the annular projection 432.2 and onward through a second valve connection 430.2 to the cleaning nozzle 318. The procedure can be repeated by the valve 360 being switched back into its air-admission position.

FIG. 5B and FIG. 5C show an actuator housing 358 of a fluid actuator 356, in particular a valve housing 362 of a valve 360 or a pump housing 392 of a pump 390, with positioning features 434 shown by way of example. FIG. 5B here shows a front view and FIG. 5C a partial side view. The actuator housing 358 preferably has positioning features 434 which are each configured to be brought into engagement with a corresponding holding feature 462 in order to fasten the fluid actuator 356 in a defined actuator position 438. A positioning feature 434 can be configured, for example, as a positioning strip 436 which can be brought into engagement with a corresponding holding feature 462 configured as a holding groove 464. A positioning feature 434 can also, as illustrated here in dashed lines, be configured as a positioning pin 437 which can be brought into engagement with a corresponding holding feature 462 configured as a holding bore 465. A holding feature 462 can be provided in a module housing 420 as an alternative or in addition to a retaining connection 446.

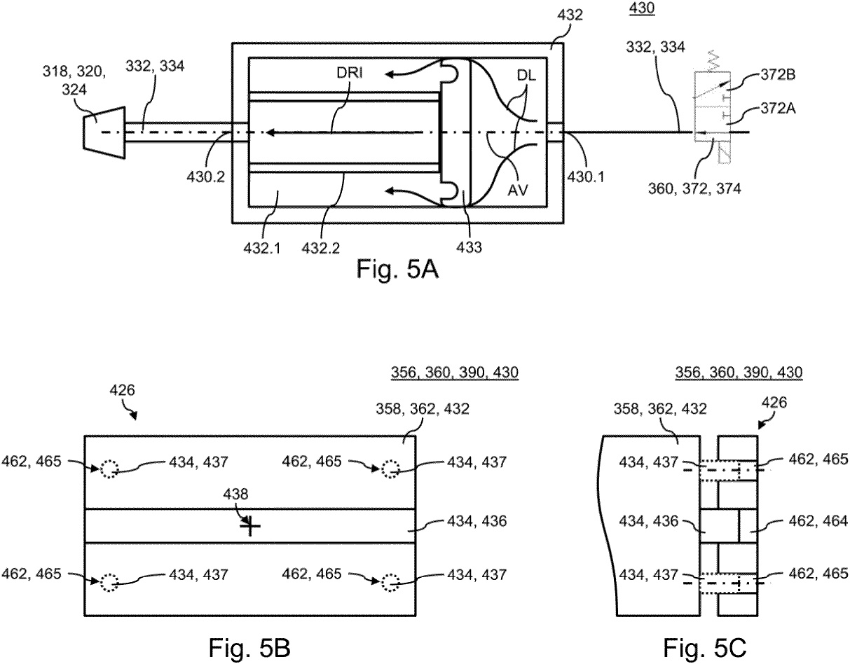

FIG. 6 shows a vehicle 1000, in particular a commercial vehicle 1002 or a car 1004, with a mirror replacement system 900 in a schematic plan view. The mirror replacement system 900 has two camera modules 400.1, 400.2 which each have a module housing 420 with a holder body 422. The first camera module 400.1 is arranged on the driver’s side 1012 and the second camera module 400.2 on the passenger’s side 1014 of the vehicle 1000.

The camera module 400 has a camera 410, not illustrated in detail here, which is connected to an electronic control unit 700 via a camera line 902 so that it can send signals. The camera 410 is configured for the optical capture EO of an outside area 3000, in particular an outside area 3004 towards the rear. The first camera module 400.1 is here arranged for the optical capture EO of a first outside area 3000.1 towards the rear on the driver’s side 1012. The second camera module 400.2 is arranged for the optical capture EO of a second outside area 3000.2 towards the rear on the passenger’s side 1014. “Towards the rear” here means in particular directed counter to a forward driving direction 1020 of the vehicle 1000 in the direction of the vehicle body axis 1010. The electronic control unit 700 is in turn connected to a playback unit 910, in particular a screen 912, for displaying the image recorded by the camera 410 so that it can send signals. In the present case, the first camera 400.1 is connected to the electronic control unit 700 via a first camera line 902.1.

The camera module 400 furthermore has a cleaning arrangement 500 which is not illustrated in detail here. The cleaning arrangement 500 is pneumatically connected to a compressed-air source 600 by means of a compressed-air fluid line 334. In the present case, the cleaning arrangement 500 of the first camera module 400.1 is fluidically connected to the compressed-air source 600 via a first compressed-air fluid line 334.1. In the present case, the cleaning arrangement 500 of the first camera module is connected to the liquid source 660 by means of a first liquid fluid line 336.1. Where a camera module 400, in particular the first and/or second camera module 400.1, 400.2, has one or more fluid actuators 356 for switching or conveying a cleaning fluid RF, in particular valves 360 or pumps 390, the mirror replacement system 900 also has one or more electrical control lines 904 for selectively electrically switching these fluid actuators 356 via the electronic control unit 700 or a further control unit. In the present case, the first camera module 400.1 is connected to the electronic control unit 700 via a first valve control line 904.1 so that it can send signals.

The explanations made above for the first camera module 400.1 apply in a similar fashion with corresponding numbering for the second camera module 400.2.

A plurality, in particular all, of the lines 334, 336, 902, 904 described here can advantageously be routed as a line bundle 920 through the vehicle 1000 and/or the module housing 420 at least over parts of the distance leading to the camera module 400. Such a line bundle 920 can in particular include a hose or net or similar elongated, in particular flexible means for bundling the lines 334, 336, 902, 904. The installation and/or the repair of a camera module 400 can advantageously be simplified by means of a line bundle 920. Optionally, the vehicle can have a fluid supply module 200 which includes a compressed-air source 600 and/or a liquid source 660 or is fluidically connected thereto, and is configured for the supplying of at least one cleaning fluid RF to the cleaning arrangement. The module housing 420 with the holder body 422 and the retaining device 426 advantageously allows a flexible configuration of cleaning arrangements 500. Different cleaning arrangements 500 can advantageously be produced by virtue of the presence of actuator holders 428 and/or line guides 450 and/or line retainers 440 in standard arrangements, wherein the module housing 420 does not need to be adapted or only slightly. In particular, for this purpose fluid actuators 356 have identical or similar external dimensions such that exchangeability of different fluid actuators 356 in an actuator holder 428 is possible.

It is understood that the foregoing description is that of the preferred embodiments of the invention and that various changes and modifications may be made thereto without departing from the spirit and scope of the invention as defined in the appended claims.

List of reference signs (part of the description)

| | |
|---|---|
| 220 | pressure cylinder |
| 222 | air chamber |
| 223 | air chamber connection |
| 224 | liquid chamber |
| 225 | liquid chamber connection |
| 226 | divider |
| 227 | cylinder ram |
| 228 | restoring spring |
| 229 | sealing ring |
| 260 | connecting fluid line |
| 318 | cleaning nozzle |
| 320 | compressed-air cleaning nozzle |
| 322 | liquid cleaning nozzle |
| 324 | combination nozzle |
| 324.1 | combination connection |
| 324.2 | compressed-air cleaning connection |
| 324.3 | liquid cleaning connection |
| 325 | nozzle body |
| 326 | line junction |
| 328 | combination line |
| 332 | fluid line |
| 333 | line body |
| 334 | compressed-air fluid line |
| 335 | compressed-air line body |
| 336 | liquid fluid line |
| 337 | liquid line body |
| 338 | plug-in connection |
| 340 | nozzle holder |
| 342 | compressed-air nozzle holder |
| 344 | liquid nozzle holder |
| 356 | fluid actuator |
| 358 | actuator housing |
| 360 | valve |
| 362 | valve housing |
| 364 | 2/2-way valve |
| 366 | 2/2-way magnetic valve |
| 368 | pneumatic 2/2-way valve |
| 370 | hydraulic 2/2-way valve |
| 372 | 3/2-way valve |
| 372A | air-admission position of the 3/2-way valve |
| 372B | air-release position of the 3/2-way valve |
| 374 | pneumatic 3/2-way valve |
| 380 | non-return valve |
| 380.1, 380.2, 380.3, 380.4 | first to fourth non-return valve |
| 390 | pump |
| 392 | pump housing |
| 410 | camera |
| 412 | lens surface |
| 414 | viewing opening |
| 420 | module housing |
| 421 | housing wall |
| 422 | holder body |
| 423 | holder opening |
| 424 | camera mount |
| 426 | retaining device |
| 428 | actuator holder |
| 429 | valve holder |
| 430 | quick air-release valve |
| 430.1 | first valve connection |
| 430.2 | second valve connection |
| 432 | quick air-release valve housing |
| 432.1 | charging space |
| 432.2 | annular projection |
| 433 | valve ram |
| 434 | positioning feature |
| 436 | positioning plug |
| 437 | positioning pin |
| 438 | actuator position |
| 440 | line retainer |
| 440.1 | single line retainer |
| 440.2 | double line retainer |
| 441 | line holder |
| 442 | line clip |
| 442.1 | single line clip |
| 442.2 | double line clip |
| 444 | retaining strap |
| 445 | retaining strap holder |
| 446 | retaining connection |
| 447 | line retaining strap |
| 448 | combination retainer |
| 449 | combination clip |
| 450 | line guide |
| 452 | compressed-air line guide |
| 454 | liquid line guide |
| 456 | hollow channel |
| 457 | line retaining strap holder |
| 462 | holding feature |
| 464 | holding groove |
| 465 | holding bore |
| 466 | fastening clip |
| 480 | line connection |
| 482 | plug-in connection |
| 484 | clamping bushing |
| 486 | pump holder |
| 488 | screw connection |
| 488A | bulkhead screw connection |
| 488B | hose connector |
| 488C | plug-in screw connection |
| 489 | thread |
| 490 | vehicle side of the module housing |
| 492 | step side of the module housing |
| 494 | nut |
| 495 | insert thread |
| 500 | cleaning arrangement |
| 536 | inner wall |
| 600 | compressed-air source |
| 610 | compressed-air supply system |
| 660 | liquid source |
| 662 | windscreen water tank |
| 700 | electronic control unit |
| 900 | mirror replacement system |
| 902 | camera line |
| 902.1, 902.2 | first, second camera line |
| 904 | control line, electrical control line |
| 904.1, 904.2 | first, second control line |
| 910 | playback unit |
| 912 | screen |
| 920 | line bundle |
| 1000 | vehicle |
| 1002 | commercial vehicle |
| 1004 | car |
| 1008 | A-pillar |
| 1010 | vehicle body axis |
| 1012 | driver’s side of the vehicle |
| 1014 | passenger’s side of the vehicle |
| 1020 | forward driving direction of the vehicle |
| 3000 | outside area |
| 3004 | outside area towards the rear |
| AM | module axis |
| AS | ram surface area |
| AV | valve axis of the quick air-release valve |
| DL | compressed air |
| DRI | compressed-air cleaning pulse |
| DS | stream of compressed air |
| EO | optical capture |
| F | liquid |
| FB | applied force |
| FR | restoring force |
| FRI | liquid cleaning pulse |
| FS | stream of liquid |
| K | spring constant |
| RF | cleaning fluid |
| VF | liquid chamber volume |
| VL | air chamber volume |
| VZ | cylinder volume |

1. A module housing for a mirror replacement system, the module housing comprising:
a holder body defining at least one holder opening and at least one viewing opening of a camera mount for fastening a camera;
said at least one viewing opening enabling a view for the camera from the module housing;
said holder body further having a retaining device for a cleaning arrangement;
wherein the cleaning arrangement has a cleaning nozzle and a fluid line for a cleaning fluid with at least one line body;
said retaining device having a line holder for the fluid line and a nozzle holder for said cleaning nozzle; and,
said nozzle holder being arranged such that the cleaning fluid can be applied from the cleaning nozzle to said at least one viewing opening.

2. The module housing of claim 1, wherein the cleaning nozzle is attached to the fluid line with a plug-in connection.

3. The module housing of claim 1, wherein said line holder has at least one of a line guide and a line retainer.

4. The module housing of claim 3, wherein at least one of:
said line retainer is a line clip or a line retaining strap; and,
said line guide is formed as a hollow channel in said holder body.

5. The module housing of claim 1, wherein a line connection is formed as a clamping bushing for the fluid line in said holder body.

6. The module housing of claim 1, wherein the fluid line has a compressed-air fluid line for compressed air.

7. The module housing of claim 1, wherein the fluid line has a liquid fluid line for a liquid.

8. The module housing of claim 1, wherein said retaining device has an actuator holder for a fluid actuator; and, said actuator holder has a retaining connection.

9. The module housing of claim 8, wherein said retaining connection is formed via a fastening clip or a retaining strap and said actuator holder is connected to the line guide.

10. The module housing of claim 8, wherein said fluid actuator is a valve, a quick air-release valve, a pressure cylinder, or a pump.

11. The module housing of claim 8, wherein said retaining connection has a fastening clip for fastening the fluid actuator.

12. The module housing of claim 8, wherein said retaining device has a holding feature configured to be brought into engagement with a positioning feature of an actuator housing.

13. The module housing of claim 3, wherein said line retainer is at least one of a single line retainer, double line retainer, a single line clip, and a double line clip.

14. A mirror replacement system for attachment to a vehicle, the mirror replacement system comprising:
a module housing;
a cleaning arrangement including a cleaning nozzle and a fluid line;
said module housing including a holder body defining at least one holder opening and at least one viewing opening of a camera mount for fastening a camera;
said at least one viewing opening enabling a view for the camera from said module housing;
said holder body further having a retaining device for a cleaning arrangement;
wherein the cleaning arrangement has a cleaning nozzle and a fluid line for a cleaning fluid with at least one line body;
said retaining device having a line holder for said fluid line and a nozzle holder for said cleaning nozzle;
said nozzle holder being arranged such that the cleaning fluid can be applied from said cleaning nozzle to said at least one viewing opening; and,
said cleaning arrangement being held in said retaining device.

15. The mirror replacement system of claim 14, wherein said cleaning nozzle is a compressed air cleaning nozzle, a liquid cleaning nozzle, or a combination nozzle.

16. The mirror replacement system of claim 14 further comprising the camera being held in said camera mount of said holder body; and, said camera having a lens surface arranged in said viewing opening of said camera mount.

17. The mirror replacement system of claim 14, wherein:
said cleaning arrangement has a quick air-release valve configured to receive compressed air and to supply a compressed-air cleaning pulse to said cleaning nozzle; and,
said quick air-release valve is held in said retaining device.

18. The mirror replacement system of claim 17, wherein said quick air-release valve has a valve housing with a positioning feature in order to fix an actuator position of said valve housing relative to said module housing.

19. The mirror replacement system of claim 18, wherein said positioning feature is a positioning plug configured to be brought into contact engagement with a holding feature.

20. The mirror replacement system of claim 19, wherein said holding feature is a receiving plug connection of said holder body.

21. The mirror replacement system of claim 14 further comprising a fluid supply module configured to supply at least one of a compressed-air cleaning pulse, a stream of compressed air, a liquid cleaning pulse, and a stream of liquid.

22. A vehicle comprising:
the module housing of claim 1;
a compressed-air supply system for supplying compressed air; and,
said module housing being arranged and configured such that the camera is arranged with a lens surface for an optical capture of an outside area of the mirror replacement system.

23. A vehicle comprising:
a mirror replacement system for attachment to the vehicle;
said mirror replacement system including a module housing and a cleaning arrangement;
said cleaning arrangement including a cleaning nozzle and a fluid line;
said module housing including a holder body defining at least one holder opening and at least one viewing opening of a camera mount for fastening a camera;
said at least one viewing opening enabling a view for the camera from said module housing;
said holder body further having a retaining device for a cleaning arrangement;
wherein the cleaning arrangement has a cleaning nozzle and a fluid line for a cleaning fluid with at least one line body;
said retaining device having a line holder for said fluid line and a nozzle holder for said cleaning nozzle;
said nozzle holder being arranged such that the cleaning fluid can be applied from said cleaning nozzle to said at least one viewing opening;
said cleaning arrangement being held in said retaining device
a compressed-air supply system for supplying compressed air; and,
said mirror replacement system being arranged and configured such that the camera is arranged with a lens surface for an optical capture of an outside area of said mirror replacement system.
